(19) United States
(12) Patent Application Publication
(10) Pub. No.: US 2018/0367451 A1
(43) Pub. Date: Dec. 20, 2018

(54) OPTIMIZED PROTOCOL INDEPENDENT MULTICAST ASSERT MECHANISM

(71) Applicant: CISCO TECHNOLOGY, INC., San Jose, CA (US)

(72) Inventors: Sameer R. Gulrajani, Fremont, CA (US); Karthik Subramanian, Cupertino, CA (US); Swadesh Agrawal, San Jose, CA (US)

(73) Assignee: CISCO TECHNOLOGY, INC., San Jose, CA (US)

(21) Appl. No.: 15/625,855

(22) Filed: Jun. 16, 2017

(51) Int. Cl. H04L 12/741; H04L 12/761

(52) U.S. Cl. CPC H04L 45/54; H04L 45/16

(57) ABSTRACT

In a network environment using a PIM (Protocol Independent Multicast) multicast routing protocol, an Assert mechanism is implemented wherein a provider-edge (PE) device sends an Assert message on the Default MDT (multicast distribution tree) and causes selection of an Assert winner, wherein any ingress PE not selected as the Assert winner stops forwarding the data packets on the Data MDT; and the Assert winner sends periodic PIM control messages on the Default MDT to maintain the Assert state on all ingress PE routers until canceled or timed out. The Assert message is created in response to MDT Mapping from at least one other ingress PE device. The PIM control messages may contain a special bit extension which forces an RPF (reverse path forwarding) neighbor to keep pointing to the Assert winner until a PIM neighborship-down event is detected. This obviates the need for periodic Assert messaging and/or data packet punting.

### TECHNICAL FIELD

This disclosure relates in general to the field of communications and, more particularly, to methods and systems for forwarding of multicast traffic in multi-homed networks without duplication of multicast packets.

### BACKGROUND

PIM (Protocol Independent Multicast) is a multicast routing protocol that can use the underlying unicast routing information base or a separate multicast-capable routing information base, to discover whether the multicast packet has arrived on the correct interface. It builds unidirectional shared trees rooted at a Rendezvous Point (RP) per group, and it optionally creates shortest-path trees per source. Packet forwarding in a router can be divided into two types: unicast forwarding and multicast forwarding. Unicast forwarding is concerned with where the packet is going whereas multicast forwarding is concerned with where the packet came from. Multi-homed networks conventionally employ an Assert mechanism to designate or select a single router for forwarding multicast data packets from sources to receivers to avoid duplicate transmission of data packets. This disclosure aims to improve on prior art Assert mechanisms that rely on detecting duplicate data packets transmitted on the data multicast distribution tree that connects several provider edge (PE) devices.

### BRIEF DESCRIPTION OF THE DRAWINGS

To provide a more complete understanding of the present disclosure and features and advantages thereof, reference is made to the following description, taken in conjunction with the accompanying Figures, wherein like reference numerals represent like parts, in which:

FIG. 1 illustrates schematically a simplified multicast network with an implemented Assert mechanism;

FIG. 2 illustrates a process flow of an Assert mechanism operating according to a first embodiment in accordance with the disclosure; and

FIG. 3 illustrates a process flow of an Assert mechanism operating according to a second embodiment in accordance with the disclosure;

FIG. 4 illustrates the format of a Hello message;

FIG. 5 illustrates the format of an Assert message;

FIG. 6 illustrates an exemplary network device suitable for implementing various embodiments of the present disclosure; and

FIGS. 7 and 8 illustrate exemplary systems, according to some embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF EXEMPLARY EMBODIMENTS

### Overview

Various embodiments of the present disclosure relate to assisting forwarding of multicast traffic over multicast Virtual Private Network (mVPN) from a multicast source to a host destination that expressed interest in receiving the multicast traffic, the host destination being multi-homed to multiple provider edge (PE) devices (sometimes interchangeably referred to as “PE nodes”). As used herein, the term “multicast source” refers to any computing/storage device that functions as a source of distributing multicast content, while the term “host destination” (sometimes interchangeably referred to as host, host device, or customer/client device) refers to any computing/storage device that consumes multicast content. PE devices are network elements that assist in delivering multicast traffic from the multicast source to one or more hosts. As used herein, the term “network element” is meant to encompass servers, processors, modules, routers, switches, cable boxes, gateways, bridges, load balancers, firewalls, inline service nodes, proxies, or any other suitable device, component, element, or proprietary appliance operable to exchange information in a network environment. A network element may include any suitable hardware, software, components, modules, or interfaces that facilitate the operations thereof, and may be inclusive of appropriate algorithms and communication protocols that allow for the effective exchange of data or information.

Network Environment: Basics of Multi-Homed mVPN Networks

For purposes of illustrating the techniques for assisting forwarding of multicast traffic over mVPN from a multicast source to a host, described herein, it is important to understand the activities that may be present in a typical network environment. The following foundational information may be viewed as a basis from which the present disclosure may be properly explained. Such information is offered for purposes of explanation only and, accordingly, should not be construed in any way to limit the broad scope of the present disclosure and its potential applications.

A computer network can include a system of hardware, software, protocols, and transmission components that collectively allow separate devices to communicate, share data, and access resources, such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay and software-defined networks, such as virtual extensible local area networks (VXLANs), and virtual networks such as virtual LANs (VLANs) and virtual private networks (VPNs).

LANs typically connect nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by intermediate network nodes, such as routers, switches, hubs, or access points (APs), which can effectively extend the size or footprint of the network.

A service provider network can provide service to customer networks via network elements referred to as Provider Edge (PE) devices (e.g. routers or switches) that are located at the edge of a service provider network. The PE devices in a service provider network may be connected by a Multi-Protocol Label Switching (MPLS)/Internet Protocol (IP) network/infrastructure that provides benefits such as fast-reroute and resiliency. The PE devices may also be connected by an IP infrastructure that utilizes Generic Routing Encapsulation (GRE) tunneling or other IP tunneling between the PE devices.

In some cases, each PE device may be connected directly to a host or a Customer Edge (CE) device, where the term “CE device” (also referred to as a “CE node” or simply “CE”) refers to a network element located at the edge of a customer network and serving as a communications medium for one or more hosts in the customer network which are connected to it.

In the following, unless specified otherwise, descriptions referring to a “host” refer both to hosts connected to the PE device(s) directly as well as to hosts connected to the PE device(s) via their corresponding CE devices. Furthermore, unless specified otherwise, descriptions provided herein are applicable to various forms of encapsulation known in the art.

Network Environment: Basics of Multi-Homed mVPN Networks

For purposes of illustrating the techniques for assisting forwarding of multicast traffic over mVPN from a multicast source to a host, described herein, it is important to understand the activities that may be present in a typical network environment. The following foundational information may be viewed as a basis from which the present disclosure may be properly explained. Such information is offered for purposes of explanation only and, accordingly, should not be construed in any way to limit the broad scope of the present disclosure and its potential applications.

As previously described herein, a computer network can include a system of hardware, software, protocols, and transmission components that collectively allow separate devices to communicate, share data, and access resources, such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay and software-defined networks, such as virtual extensible local area networks (VXLANs), and virtual networks such as virtual LANs (VLANs) and virtual private networks (VPNs).

LANs typically connect nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by intermediate network nodes, such as routers, switches, hubs, or access points (APs), which can effectively extend the size or footprint of the network.

A service provider network can provide service to customer networks via network elements referred to as Provider Edge (PE) devices (e.g. routers or switches) that are located at the edge of a service provider network. The PE devices in a service provider network may be connected by an Multi-Protocol Label Switching (MPLS)/Internet Protocol (IP) network/infrastructure that provides benefits such as fast-reroute and resiliency. The PE devices may also be connected by an IP infrastructure that utilizes Generic Routing Encapsulation (GRE) tunneling or other IP tunneling between the PE devices.

In some cases, each PE device may be connected directly to a host or a Customer Edge (CE) device, where the term “CE device” (also referred to as a “CE node” or simply “CE”) refers to a network element located at the edge of a customer network and serving as a communications medium for one or more hosts in the customer network which are connected to it.

In the following, unless specified otherwise, descriptions referring to a “host” refer both to hosts connected to the PE device(s) directly as well as to hosts connected to the PE device(s) via their corresponding CE devices. Furthermore, unless specified otherwise, descriptions provided herein are applicable to various forms of encapsulation known in the art.

### Protocol Independent Multicast (PIM)

Request For Comments (RFC) 7761 by the Internet Engineering Task Force (IETF), entitled “Protocol Independent Multicast—Sparse Mode (PIM-SM): Protocol Specification (Revised)” and included by reference herein in its entirety, defines Protocol Independent Multicast (PIM) for efficiently routing multicast groups that may span wide-area (and inter-domain) internets. Although this protocol may use the underlying unicast routing to provide reverse-path information for multicast tree building, it is not dependent on any particular unicast routing protocol.

PIM relies on an underlying topology-gathering protocol to populate a routing table with routes. This routing table is called the Multicast Routing Information Base (MRIB). The routes in this table may be taken directly from the unicast routing table, or they may be different and provided by a separate routing protocol such as MBGP. Regardless of how it is created, the primary role of the MRIB in the PIM protocol is to provide the next-hop router along a multicast-capable path to each destination subnet. The MRIB is used to determine the next-hop neighbor to which any PIM Join/Prune message is sent. Data flows along the reverse path of the Join messages. Thus, in contrast to the unicast RIB, which specifies the next hop that a data packet would take to get to some subnet, the MRIB gives reverse-path information and indicates the path that a multicast data packet would take from its origin subnet to the router that has the MRIB.

PIM must be able to route data packets from sources to receivers without either the sources or receivers knowing a priori of the existence of the others. This is essentially done in three phases, although as senders and receivers may come and go at any time, all three phases may occur simultaneously.

### Phase One: RP Tree

In phase one, a multicast receiver expresses its interest in receiving traffic destined for a multicast group. One of the receiver's local routers is elected as the Designated Router (DR) for that subnet. On receiving the receiver's expression of interest, the DR then sends a PIM Join message towards the RP for that multicast group. This Join message is known as a (*,G) Join because it joins group G for all sources to that group. The (*,G) Join travels hop-by-hop towards the RP for the group, and in each router it passes through, multicast tree state for group G is instantiated. Eventually, the (*,G) Join either reaches the RP or reaches a router that already has (*,G) Join state for that group. When many receivers join the group, their Join messages converge on the RP and form a distribution tree for group G that is rooted at the RP. This is known as the RP Tree (RPT), and is also known as the shared tree because it is shared by all sources sending to that group. Join messages are resent periodically so long as the receiver remains in the group. When all receivers on a leaf-network leave the group, the DR will send a PIM (*,G) Prune message towards the RP for that multicast group. However, if the Prune message is not sent for any reason, the state will eventually time out. A multicast data sender just starts sending data destined for a multicast group. The sender's local router (DR) takes those data packets, unicast-encapsulates them, and sends them directly to the RP. The RP receives these encapsulated data packets, decapsulates them, and forwards them onto the shared tree. The packets then follow the (*,G) multicast tree state in the routers on the RP Tree, being replicated wherever the RP Tree branches, and eventually reaching all the receivers for that multicast group. The process of encapsulating data packets to the RP is called registering, and the encapsulation packets are known as PIM Register packets. At the end of phase one, multicast traffic is flowing encapsulated to the RP, and then natively over the RP tree to the multicast receivers.

### Phase Two: Register-Stop

Encapsulation and decapsulation may be relatively expensive operations for a router to perform, depending on whether or not the router has appropriate hardware for these tasks.

When the RP receives a register-encapsulated data packet from source S on group G, it will normally initiate an (S,G) source, or source group pair, specific Join towards S. This Join message travels hop-by-hop towards S, instantiating (S,G) multicast tree state in the routers along the path. (S,G) multicast tree state is used only to forward packets for group G if those packets come from source S. Eventually the Join message reaches S's subnet or a router that already has (S,G) multicast tree state, and then packets from S start to flow following the (S,G) tree state towards the RP. These data packets may also reach routers with (*,G) state along the path towards the RP; if they do, they can shortcut onto the RP tree at this point. While the RP is in the process of joining the source-specific tree for S, the data packets will continue being encapsulated to the RP. When packets from S also start to arrive natively at the RP, the RP will be receiving two copies of each of these packets. At this point, the RP starts to discard the encapsulated copy of these packets, and it sends a Register-Stop message back to S's DR to prevent the DR from unnecessarily encapsulating the packets. At the end of phase two, traffic will be flowing natively from S along a source-specific tree to the RP, and from there along the shared tree to the receivers. Where the two trees intersect, traffic may transfer from the source-specific tree to the RP tree and thus avoid taking a long detour via the RP.

### Phase Three: Shortest-Path Tree

Phase Three ensures that the receiver will be receiving traffic from S along the shortest-path tree between the receiver and S.

Complications can occur when using multi-access LANs, such as the Ethernet, for transit of data packets. For example, two or more paths on the RP tree may be set up, causing multiple copies of all the shared tree traffic to appear on the LAN. These problems are caused by the presence of more than one upstream router with join state for the group or source-group pair. PIM does not prevent such duplicate joins from occurring; instead, when duplicate data packets appear on the LAN from different routers, these routers notice this and then elect a single forwarder. This election is performed using PIM Assert messages, which resolve the problem in favor of the upstream router that has (S,G) state; or, if neither router or both routers have (S,G) state, then the problem is resolved in favor of the router with the best metric to the RP for RP trees, or the best metric to the source for source-specific trees. These Assert messages are also received by the downstream routers on the LAN, and these cause subsequent Join messages to be sent to the upstream router that won the Assert.

Where multiple PIM routers peer over a shared LAN, it is possible for more than one upstream router to have valid forwarding state for a packet, which can lead to packet duplication. PIM does not attempt to prevent this from occurring. Instead, it detects when this has happened and elects a single forwarder amongst the upstream routers to prevent further duplication. This election is performed using PIM Assert messages. Assert messages are also received by downstream routers on the LAN, and these cause subsequent Join/Prune messages to be sent to the upstream router that won the Assert.

In general, a PIM Assert message should only be accepted for processing if it comes from a known PIM neighbor. A PIM router hears about PIM neighbors through PIM Hello messages. If a router receives an Assert message from a particular IP source address and it has not seen a PIM Hello message from that source address, then the Assert message should be discarded without further processing.

An Assert winner is a router that has won an (S,G) assert on an interface I. It is now responsible for forwarding traffic from S destined for G out of interface I. Irrespective of whether it is the DR for the interface I, a router that is the assert winner is also responsible for forwarding traffic onto interface I on behalf of local hosts on interface I that have made membership requests that specifically refer to S (and G). An Assert loser is a router that has lost an (S,G) assert on interface I. It must not forward packets from S destined for G onto interface I. If it is the DR on the interface I, it is no longer responsible for forwarding traffic onto the interface I to satisfy local hosts with membership requests that specifically refer to S and G.

This idea underlying the present disclosure aims to optimize the PIM Assert mechanism by preventing multiple routers from forwarding the same multicast flows on a multi-access link or multi-access segment, when a router forwarding a multicast flow detects data packets for that same flow on its outgoing interface.

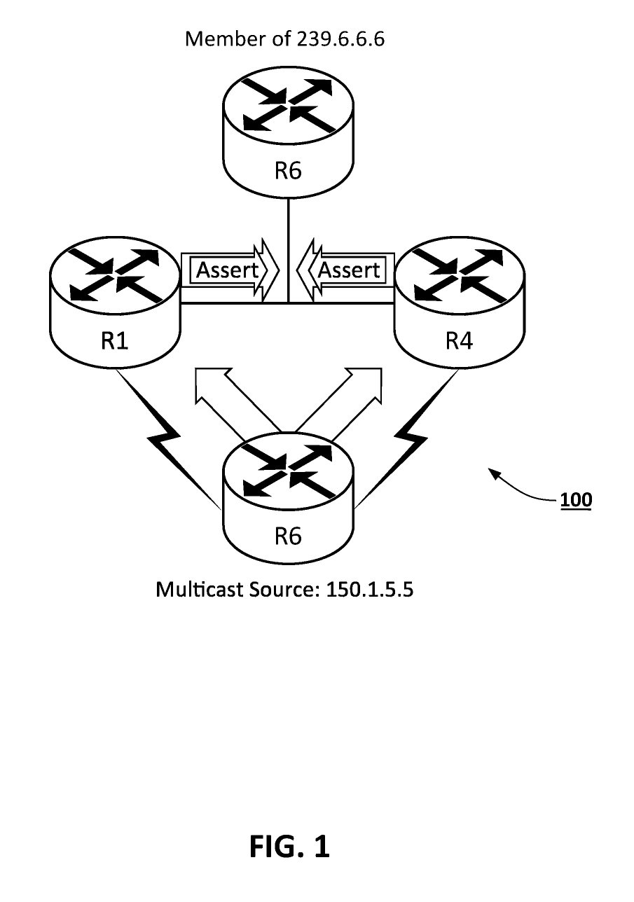

FIG. 1 illustrates schematically an exemplary network topology as described above. As shown in FIG. 1, a network 100 may be a multicast environment with a source router R5 (the multicast source) having the exemplary source address 150.1.5.5; two PE routers R1 and R4 each connected to the source router R5, and a destination router R6 (multicast group 239.6.6.6) connected to both R1 and R4 and thus sharing a multi-access connection to R5. Both R1 and R4 are receiving copies of the same multicast packets from the source router R5. It is not very efficient for both routers to forward the packets onto the same network segment R6, since this would as mentioned above result in duplicate traffic and waste bandwidth and processing power.

To stop this duplication of shared traffic, PIM routers connected to a shared segment will elect a single forwarder for that particular segment. Since PIM does not have its own routing protocol that could be used to determine the best path to send data across, it relies on a special process called the PIM Assert Mechanism to make this determination.

The PIM Assert Mechanism tells a router that when it receives a multicast packet from a particular source on an interface that is already listed in its own Outbound Interface List (OIL) for the same (S,G) pair, that it needs to send an Assert Message. Assert Messages contain the metric of the unicast route to the source in question, the Administrative Distance (AD) of the protocol that discovered the route, the multicast source and the group itself, and are used to elect what is called the PIM Forwarder.

In the scenario in FIG. 1, both R1 and R4 will send the same multicast stream to R6. This means they will put their VLAN 146 interfaces into the OIL for the (S,G) pair (150.1.5.5, 239.6.6.6) and because this is a single LAN segment, subsequently also referred to as a multi-access link or multi-access segment, each device will see each the others data stream. This condition, i.e. each router producing duplicate packets on the same segment, will trigger the Assert Mechanism. As mentioned above and to be discussed in more detail below, problems with duplicate packets may arise when packets from different routers are not transmitted on the same segment.

A person of ordinary skill in the art will recognize that the topology illustrated in FIG. 1 is only one possible example and that, in other implementations, any other number of customer networks, source and destination routers within each customer (“C) network, and PE routers within a provider (“P”) network may be used.

These Assert Messages are used to elect the PIM Forwarder using the following three rules:
1. The router generating an Assert with the lowest Administrative Distance (AD) is elected the forwarder. The AD would only differ if the routes to R5 where from different routing protocols. If the AD's are identical then the rule selection goes to step 2.
2. The best unicast routing metric is used to break a tie if the AD's are identical. The combination of AD and the unicast routing metric is referred to as a “tuple”. If metrics are identical then the rule selection goes to step 3.
3. The device with the highest IP Address will be elected as the PIM Forwarder.

According to exemplary disclosed embodiments, a PIM Assert process may be triggered when a PE router sees data packets for the same data flow coming in on its outgoing data interface that forwards data on the Data MDT. When identical data packets from several PE routers are detected, the PE router that won the Assert (Assert winner) sends Assert messages to downstream routers on the LAN. One of the issues with the current Assert mechanism is that it requires packets to be signaled/punted to the RP (Route processor line card) and that thereafter a periodic Assert message needs to be sent to refresh the Assert state. The embodiments described in the present disclosure obviate the need for decapsulating data and/or periodically refreshing the Assert state. Every multicast packet received on an interface I at a router is subject to a (Reverse Path Forwarding) RPF check, which determines whether the packet is forwarded or dropped and prevents looping of packets in the network.

For a better understanding of the disclosure, the role of two types of Multicast Distribution Trees (MDT's) configured to transmit control messages and data in mVPN networks will now be briefly described. MDT's are multicast tunnels through the P-network (Provider network). MDT's transport customer multicast traffic encapsulated in GRE's (Generic Routing Encapsulation) that are part of the same multicast domain. The two types of MDT's are as follows:

The first type referred to as Default-MDT is used to send low-bandwidth multicast traffic or traffic that is destined to a widely distributed set of receivers. The Default-MDT is always used to send multicast control traffic between PE routers in a multicast domain. When a traffic threshold is exceeded on the Default-MDT, the PE router that is connected to the VPN source of the multicast traffic can switch the (S, G) from the Default-MDT to a group associated with the Data-MDT (see below). All multicast control traffic travels on the Default-MDT to ensure that all PE routers receive control information.

The second type referred to as Data-MDT is used to tunnel high-bandwidth source traffic through the P-network to interested PE routers that have active VPN receivers. Data-MDT's thus avoid unnecessary flooding of customer multicast traffic to all PE routers in a multicast domain. The Data-MDT is only created for data traffic and can be set up dynamically.

According to some embodiments of the disclosure, the Assert process may be triggered solely based on PIM control messages sent over the default MDT. Two scenarios may exist: (1) When either or both Ingress PEs are forwarding packets only on the default MDT, then an Assert mechanism gets triggered to ensure only one of them is forwarding; (2) when both Ingress PEs are forwarding packets on their respective data MDT, they are not aware of each other's traffic so that the Assert mechanism does not kick in, resulting in potential duplicate traffic. In prior art embodiments, Assert mechanisms can be triggered only if each Ingress PE joins each other's data MDT. Only then are the Ingress PE's able to see each other's traffic, to trigger the Assert mechanism which, however, initially causes unwanted traffic to reach both PEs due to packet duplication until the Assert mechanism kicks in.

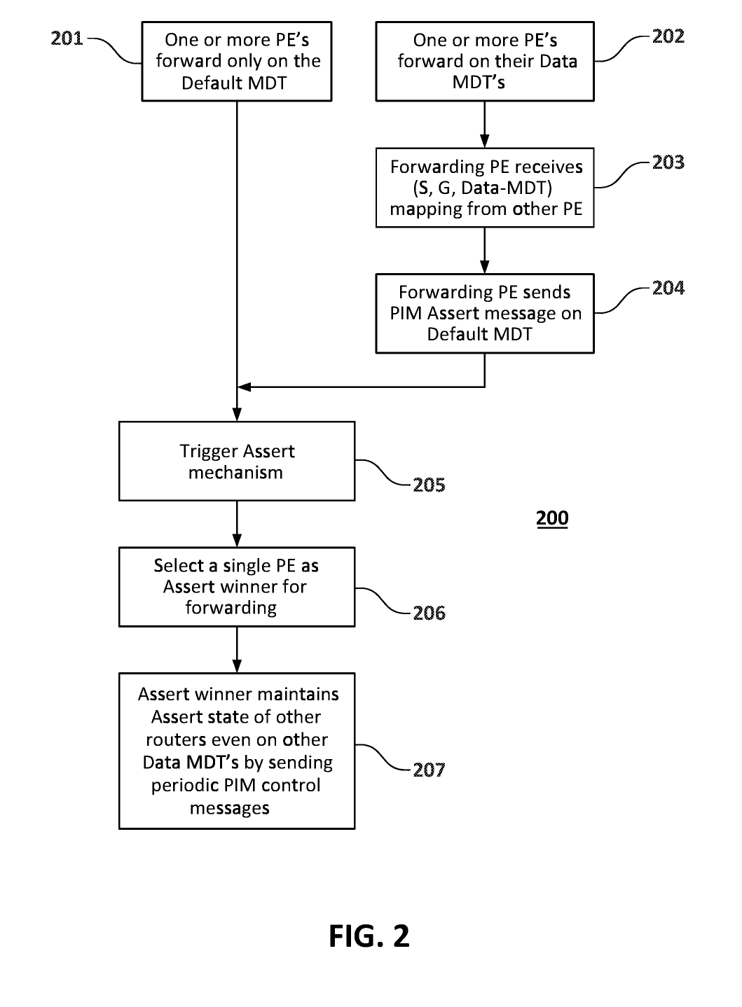

FIG. 2 shows in form of a schematic flow diagram of a process 200 for controlling the PIM Assert mechanism with control messages sent exclusively on the Default MDT. If one or more PE's forward only on the Default MDT, for example for low-bandwidth traffic, at step 201, then the Assert message is received by all connected PE's and the Assert mechanism is triggered, at step 205. Conversely, as in most realistic situations, if one or more PE's forward on their respective Data MDT's, at step 202, and if the presently forwarding PE receives (S, G, Data-MDT) mapping from another PE, at step 203, then the presently forwarding PE sends, at step 204, a PIM Assert message on the Default MDT, which is received by all PE's, regardless of the Data MDT they are using. This again triggers the Assert mechanism, at step 205. A single PE is then selected as the Assert winner, at step 206, according to a metric described above. The Assert winner thereafter keeps the Assert state on the other routers that may even be transmitting on other Data MDT's, by sending periodic PIM control messages over the Default MDT, at step 207. In the absence of periodic PIM control messages the Assert state of the Assert winner will eventually expire and a new Assert winner is selected.

In other words, whenever an Ingress PE that is forwarding data packets for a particular (S,G) flow on the Data MDT receives a Data MDT Mapping from another PE, it sends out a PIM Assert message on the Default MDT. This will initiate the PIM Assert process causing one of the Ingress PE's to stop forwarding traffic. This mechanism describes a solution to trigger an Assert mechanism when multiple PE devices are forwarding traffic for the same data flow on the Data MDT.

The Assert mechanism causes all downstream routers to switch their RPF neighbor to the Assert winner so that the future PIM Joins can be sent only to the Assert winner. As long as periodic Assert messages are sent by the Assert winner via the Default MDT, the downstream routers keep their RPF neighbor as the Assert winner.

According to some embodiments of the disclosure, the proposed method of sending out a PIM Assert message on the Default MDT does not require the ingress PE's to join each other's traffic, thereby preventing traffic from unnecessarily reaching PE devices that have no interested receiver. Moreover, this Assert message is sent on the Default MDT, which interconnects all multicast receivers and not just those on the same Data MDT. Data Packets therefore do not have to be decapsulated and signaled/punted to the route processor to trigger the Assert mechanism, making it a more optimal solution. Encapsulation and decapsulation may be relatively expensive operations for a router to perform, depending on whether or not the router has appropriate hardware for these tasks.

Since Data MDT mappings are sent via PIM control messages (i.e. via the default MDT), they are not rate-limited to the route processor and are thus able to trigger the Assert process more quickly in scaled scenarios. This mechanism may be beneficial in topologies where the Zero Threshold/immediate Data MDT switch feature is configured such that traffic is not sent on the default MDT, i.e. in situations where even low-bandwidth data traffic is always sent on the Data MDT.

According to some embodiments of the disclosure, the proposed PIM Assert mechanism does not define any new control packets and relies on existing mechanisms to trigger the PIM Assert process, i.e. nothing needs to be changed in the PIM protocol when implementing the proposed PIM Assert mechanism. As long as one of the Ingress PE devices has the proposed PIM Assert mechanism implemented, the Assert process can be triggered upon receiving the Data MDT Mapping by way of the Default MDT. With the proposed PIM Assert mechanism, there is no longer a need for Ingress PE's to join each other's Data MDT's to trigger an Assert message. Instead, Control Plane events are used to obviate the need for Data Plane events.

The Assert process may be triggered and optimized even for PE's residing on other Data MDT's solely based on PIM control messages on the Default MDT without the need for sending periodic Assert messages or punting packet to trigger the Assert mechanism. In the prior art, Assert winner messages needed to be sent periodically, for example every 60 seconds, to maintain the Assert state on other PIM routers on the segment.

When a router sends a PIM Join on a multi-access segment or multi-access link, respectively, the PIM Join is received on all PIM routers on that multi-access segment. When a router forwarding a particular (S,G) flow on a multi-access segment detects a PIM Join targeted towards another router on that same multi-access segment, it can trigger a PIM Assert message. The PIM Join sent to the other router will bring that router into the forwarding state, so the assert mechanism will prevent duplicates on that LAN. The assert mechanism causes all downstream routers to switch their RPF neighbor to the assert winner so that the future PIM Joins can be sent only to the Assert winner. As long as periodic assert messages are sent by the winner, the downstream routers keeps their RPF neighbor as the assert winner.

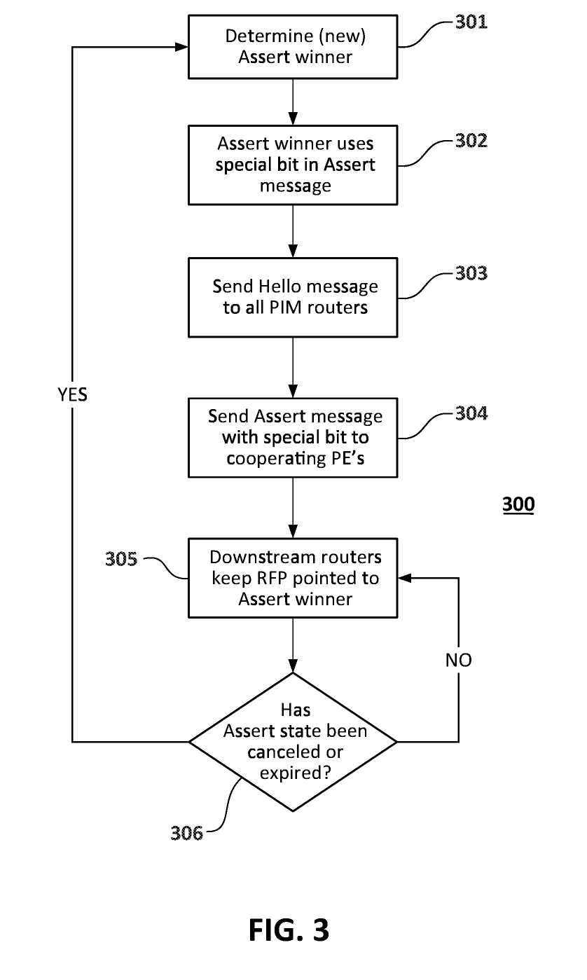

According to some embodiments of the disclosure, no more periodic assert winner messages are required and the Assert message uses instead a special bit extension in the PIM Assert Message sent by an upstream router. FIG. 3 shows in form of a schematic flow diagram of a process 300 for controlling the PIM Assert mechanism with the special bit extension in the Assert message. The process 300 starts at step 301 by determining an Assert winner using one or more of the aforedescribed methods. For example, the Assert winner may be selected with reference to step 206 of process 200 illustrated in FIG. 2. The Assert winner will then compose a special Assert message containing a special bit extension, at step 302, and send this special Assert message to all PE's or PIM routers on the group segment. Because all routers on the segment need to support this behavior, i.e. they must be able to parse the special Assert Message with the special bit extension, it is proposed to precede the special Assert Message with a Hello Option in order to ensure all devices support this extension, at step 303. In general, a PIM router should accept a PIM Assert message for processing only if it comes from a known PIM neighbor. A PIM router hears about PIM neighbors through PIM Hello messages. If a router receives an Assert message from a particular IP source address and it has not seen a PIM Hello message from that same source address, then the Assert message should be discarded without further processing. In other words, a valid Assert message from a source address is always preceded by a Hello message from that same source address. Hello messages are sent periodically by routers on all interfaces on the Default MDT.

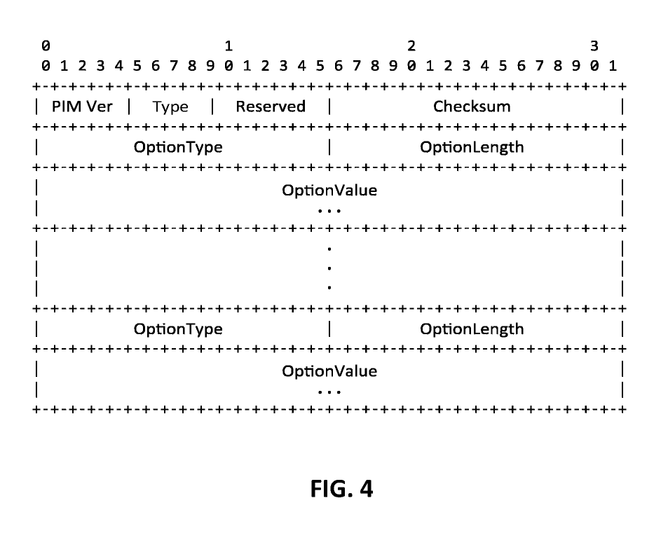

An exemplary Hello message may have the standard format depicted in FIG. 4.

The field “Type” in the PIM header is set to “0” for a Hello message. Several “OptionType” values are preassigned, but other “OptionType” values (for example 3 through 16) are reserved, but still unassigned and could be used to indicate the intent and interpretation of a particular Hello message.

A particular “OptionType” and “OptionValue” in a Hello message may be used to indicate that the Hello message is followed by a special Assert message with a special bit extension. These messages are received by a router on the Default MDT, the router checks whether it is configured to process the special Assert message, i.e. is able to interpret the special bit extension.

Returning now to FIG. 3, following the Hello message, the Assert message with the special bit extension is sent to and received by those PE routers configured to parse the special Assert message, at step 304. Downstream routers keep the RPF pointed to Assert winner, at step 305, until the Assert state is either canceled or has expired, at step 306, in which case the process 300 returns to step 301 to determine a new Assert winner.

The downstream routers receiving this Assert message with the special bit extension will keep their RPF (Reverse Path Forwarding) neighbor pointing to the Assert winner forever. If the Assert winner is gracefully going down or in route entries are cleared, it needs to send out an Assert cancel message to reset the RPF neighbors on downstream routers. If the Assert winner unexpectedly goes down, downstream routers can cancel their Assert state when the Assert Winner PIM neighborship expires. Alternately, BFD (Bidirectional Forwarding Detection) or similar options can be used to detect neighbor down events quickly.

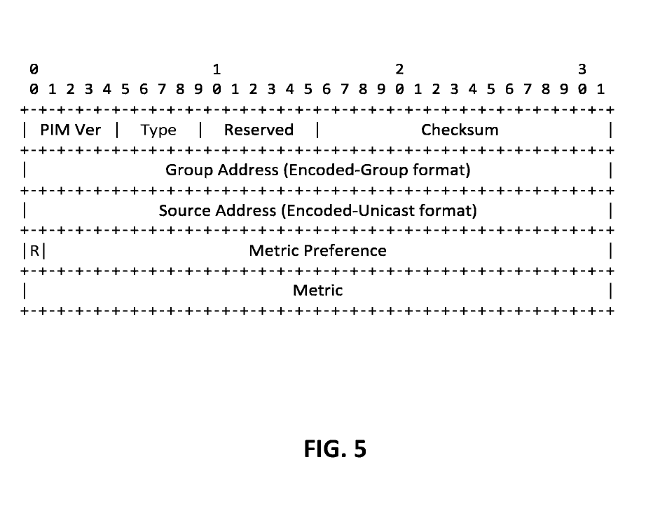

FIG. 5 illustrates an exemplary Assert message format. As discussed above, the Assert message is used to resolve forwarder conflicts between routers on a link. It is sent when a router receives a multicast data packet on an interface on which the router would normally have forwarded that packet. Assert messages may also be sent in response to an Assert message from another router.

The field “Type” in the PIM header is set to “5” for an Assert message. In the PIM Assert Message, 8 bits following the “Type” field are currently reserved and not used. Therefore, one of those bits may be used as the special bit extension. The Hello message needs to define a new option type to negotiate the capability (ensuring all routers on the LAN support this new behavior) before this Assert message with the special bit is sent out. The group address and the source address are addresses for which the router wishes to resolve the forwarding conflict. The source address may be set to zero for (*,G) asserts. The RPTbit (“R”) is a 1-bit value which is set to 1 for Assert(*,G) messages and to 0 for Assert(S,G) messages.

### Exemplary Devices

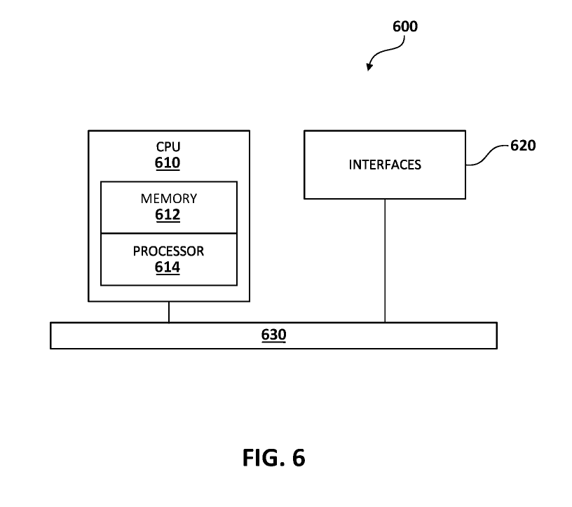

FIG. 6 illustrates an example network device 600 suitable for implementing various embodiments of the present disclosure, e.g. embodiments related to assisting forwarding of multicast traffic in an mVPN-based multi-homed network. In various embodiments, the network device 600 could be any one of or could be communicatively connected to in order to configure any one of the PE devices described herein, e.g. the network device may be used to implement a multi-homed mVPN multicast forwarding system similar to system 100 to enable functionality of various PE devices as described above.

As shown in FIG. 6, the network device 600 includes a master central processing unit (CPU) 610, interfaces 620, and a bus 630 (e.g., a PCI bus). When acting under the control of appropriate software or firmware, the CPU 610 is responsible for executing packet management, error detection, and/or routing or forwarding functions. The CPU 610 can accomplish all these functions under the control of software including an operating system and any appropriate applications software. CPU 610 may include one or more processors 614 such as a processor from the Motorola family of microprocessors or the MIPS family of microprocessors. In an alternative embodiment, processor 614 is specially designed hardware for controlling the operations of network device 600. In a specific embodiment, a memory 612 (such as non-volatile RAM and/or ROM) also forms part of CPU 610. However, there are many different ways in which memory could be coupled to the system.

The interfaces 620 are typically provided as interface cards (sometimes referred to as “line cards”). Generally, they control the sending and receiving of data packets over the network and sometimes support other peripherals used with the network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 610 to efficiently perform routing computations, network diagnostics, security functions, etc.

Although the system shown in FIG. 6 is one specific network device of the present disclosure, it is by no means the only network device architecture on which the present disclosure can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 612) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

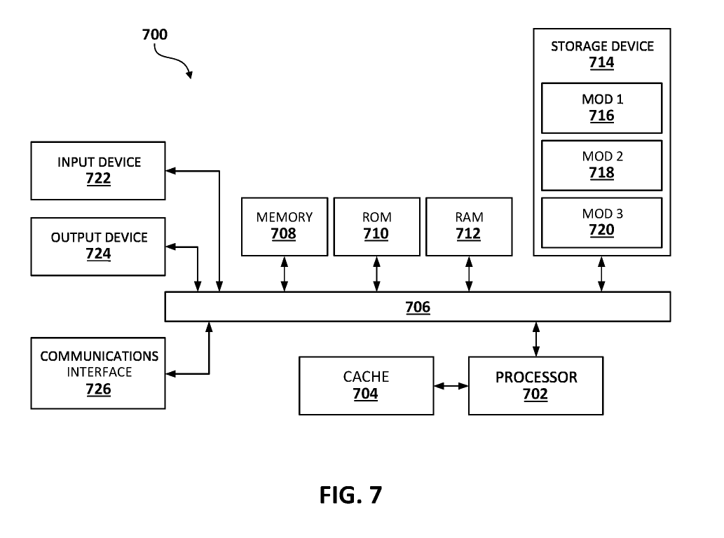

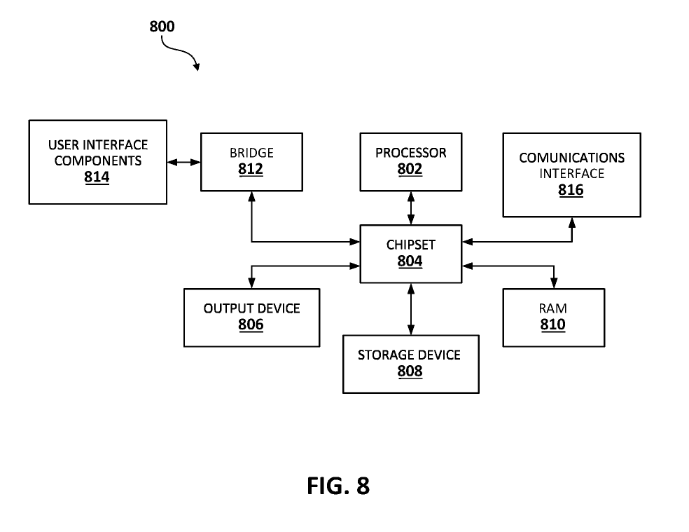

FIGS. 7 and 8 illustrate exemplary systems, according to some embodiments of the present disclosure. The more appropriate embodiment will be apparent to those of ordinary skill in the art when practicing the present technology. Persons of ordinary skill in the art will also readily appreciate that other system embodiments are possible.

Systems such as the ones shown in FIGS. 7 and 8 are also suitable for implementing various embodiments of the present disclosure, e.g. embodiments related to assisting forwarding of multicast traffic in an mVPN-based multi-homed network. In various embodiments, such systems could be any one of or could be communicatively connected to in order to configure any one of the PE devices described herein, e.g. the network device may be used to implement the multi-homed mVPN multicast forwarding system 100 to enable functionality of various PE devices as described above.

FIG. 7 illustrates a conventional computing system architecture 700 wherein the components of the system are in electrical communication with each other via a system bus. Exemplary system 700 includes a processing unit (CPU or processor) 702, communicatively connected to a system bus 706. The system bus 706 couples various system components to the processor 702, the system components including e.g. a system memory 708, a read only memory (ROM) 710, and a random access memory (RAM) 712. The system 700 may include a cache 704 of high-speed memory connected directly with, in close proximity to, or integrated as part of the processor 702. The system 700 may copy data from the memory 708 and/or the storage device 714 to the cache 704 for quick access by the processor 702. In this way, the cache 704 may provide a performance boost that avoids processor 702 delays while waiting for data. These and other modules may control or be configured to control the processor 702 to perform various actions. Other system memory 708 may be available for use as well. The memory 708 may include multiple different types of memory with different performance characteristics. The processor 702 may include any general purpose processor and a hardware module or software module, such as module MOD1 716, module MOD2 718, and module MOD3 720 stored in the storage device 714, configured to control the processor 702 as well as a special-purpose processor where software instructions are incorporated into the actual processor design. The processor 702 may essentially be a completely self-contained computing system, containing multiple cores or processors, a bus, memory controller, cache, etc. A multi-core processor may be symmetric or asymmetric.

To enable user interaction with the computing device 700, an input device 722 may represent any number of input mechanisms, such as a microphone for speech, a touch-sensitive screen for gesture or graphical input, keyboard, mouse, motion input, speech and so forth. An output device 724 may also be one or more of a number of output mechanisms known to those of skill in the art. In some instances, multimodal systems may enable a user to provide multiple types of input to communicate with the computing device 700. The communications interface 726 may generally govern and manage the user input and system output. There is no restriction on operating on any particular hardware arrangement and therefore the basic features here may easily be substituted for improved hardware or firmware arrangements as they are developed.

Storage device 714 is a non-volatile memory and may be a hard disk or other types of computer readable media which may store data that are accessible by a computer, such as magnetic cassettes, flash memory cards, solid state memory devices, digital versatile disks, cartridges, random access memories (RAMs) 712, read only memory (ROM) 710, and hybrids thereof.

The storage device 714 may include software modules 716, 718, 720 for controlling the processor 702. Other hardware or software modules are contemplated. The storage device 714 may be connected to the system bus 706. In one aspect, a hardware module that performs a particular function may include the software component stored in a computer-readable medium in connection with the necessary hardware components, such as the processor 702, bus 706, display 724, and so forth, to carry out the function.

FIG. 8 illustrates an example computer system 800 having a chipset architecture that may be used in executing the described method and generating and displaying a graphical user interface (GUI). Computer system 800 is an example of computer hardware, software, and firmware that may be used to implement the disclosed technology. System 800 may include a processor 802, representative of any number of physically and/or logically distinct resources capable of executing software, firmware, and hardware configured to perform identified computations. Processor 802 may communicate with a chipset 804 that may control input to and output from processor 802. In this example, chipset 804 outputs information to output 806, such as a display, and may read and write information to storage device 808, which may include magnetic media, and solid state media, for example. Chipset 804 may also read data from and write data to RAM 810. A bridge 812 for interfacing with a variety of user interface components 814 may be provided for interfacing with chipset 804. Such user interface components 814 may include a keyboard, a microphone, touch detection and processing circuitry, a pointing device, such as a mouse, and so on. In general, inputs to system 800 may come from any of a variety of sources, machine generated and/or human generated.

Chipset 804 may also interface with one or more communication interfaces 816 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 802 analyzing data stored in storage 808 or 810. Further, the machine may receive inputs from a user via user interface components 814 and execute appropriate functions, such as browsing functions by interpreting these inputs using processor 802.

It may be appreciated that example systems 700 and 800 may have more than one processor 702, 802, or be part of a group or cluster of computing devices networked together to provide greater processing capability.

### VARIATIONS AND IMPLEMENTATIONS

It is important to note that the steps in the appended diagrams illustrate only some of the possible scenarios and patterns that may be executed by, or within, the network environment shown in the Figures. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding example operations and use cases have been offered for purposes of example and discussion. Substantial flexibility is provided by the network environment shown in the Figures in that any suitable arrangements, chronologies, configurations, and timing mechanisms may be provided without departing from the teachings provided herein.

As used herein in this Specification, the term ‘network element’, ‘router’, forwarder, etc., such as e.g. any of the PEs R1 and R4 or other devices of the system 100 depicted in FIG. 1, is meant to encompass any of the aforementioned elements, as well as servers (physical or virtually implemented on physical hardware), machines (physical or virtually implemented on physical hardware), end user devices, routers, switches, cable boxes, gateways, bridges, load balancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate operations thereof related to solutions described herein. This may be inclusive of appropriate algorithms and communication protocols that allow for the effective exchange of data or information.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Although the claims may be presented in single dependency format, it should be understood that any claim can depend on and be combined with any preceding claim of the same type unless that is clearly technically infeasible.

What is claimed is:

1. A method for triggering an Assert mechanism with multicast traffic in multi-homed networks running a PIM (Protocol Independent Multicast) multicast routing protocol, comprising:
an ingress provider edge (PE) device, which forwards data packets for a particular (S,G) (source-group pair) data flow on a Data MDT (multicast distribution tree), receiving on a Default MDT Data MDT Mapping from at least one other ingress PE device;
the ingress PE device sending an Assert message on the Default MDT and causing selection of an Assert winner, wherein any ingress PE not selected as the Assert winner stops forwarding the data packets on the Data MDT; and
the Assert winner sending periodic PIM control messages on the Default MDT to maintain the Assert state on all ingress PE routers.

2. The method of claim 1, wherein the Assert mechanism is triggered without a need to decapsulate the data packets.

3. The method of claim 1, wherein the Assert mechanism is triggered when the ingress PE device detects a PIM Join targeted towards another ingress PE device on a same multi-access segment.

4. The method of claim 1, wherein some ingress PE's send data packets over a Data MDT that is different from a Data MDT of other ingress PE's.

5. The method of claim 1, wherein the Assert message comprises a special bit extension, wherein the special bit extension forces an RPF neighbor to keep pointing to the Assert winner until a PIM neighborship-down event is detected.

6. The method of claim 5, wherein the PIM neighborship-down event comprises an event selected from an Assert cancel message, expiration of the Assert winner state, and Bidirectional Forwarding Detection (BFD).

7. The method of claim 5, further comprising sending a Hello message with a special option field value to all connected PE devices to ensure that a PE device receiving the Assert message following the Hello message is configured to interpret the Assert message having the special bit extension.

8. An apparatus, comprising:
one or more network interfaces that communicate multicast traffic in multi-homed networks comprising a Data MDT (multicast distribution tree) and a Default MDT;
a processor coupled to the one or more network interfaces and configured to execute a process; and
a memory configured to store program instructions which contain the process executable by the processor, the process comprising:
receiving on Default MDT at an ingress provider edge (PE) device, which forwards data packets for a particular (S,G) (source-group pair)data flow on the Data MDT, Data MDT Mapping from at least one other ingress PE device;
sending from the ingress PE device a PIM Assert message on the Default MDT and causing selection of an Assert winner, wherein any ingress PE not selected as the Assert winner stops forwarding the data packets on the Data MDT; and
sending from the Assert winner periodic PIM control messages on the Default MDT to maintain the Assert state on all ingress PE routers.

9. The apparatus of claim 8, wherein the Assert winner is determined without a need to decapsulate the data packets at a PE device.

10. The apparatus of claim 8, wherein Assert mechanism is triggered when the ingress PE device detects a PIM Join targeted towards another ingress PE device on a same multi-access segment.

11. The apparatus of claim 8, wherein some ingress PE's send data packets over a Data MDT that is different from a Data MDT of other PE's.

12. The apparatus of claim 8, wherein the Assert message comprises a special bit extension, wherein the special bit extension forces an RPF neighbor to keep pointing to the Assert winner until a PIM neighborship-down event is detected.

13. The apparatus of claim 12, wherein the PIM neighborship-down event comprises an event selected from an Assert cancel message, expiration of the Assert winner state, and Bidirectional Forwarding Detection (BFD).

14. The apparatus of claim 12, wherein the process further comprises sending a Hello message with a special option field value to all connected PE devices to ensure that a PE device receiving the Assert message following the Hello message is configured to interpret the Assert message having the special bit extension.

15. A tangible non-transitory computer readable medium storing program instructions that cause a computer to execute a process, the process comprising:
receiving on a Default MDT (multicast distribution tree) at an ingress provider edge (PE) device, which forwards data packets for a particular (S,G) (source-group pair) data flow on a Data MDT, Data MDT Mapping from at least one other ingress PE device;
sending from the ingress PE device a PIM Assert message on the Default MDT and causing selection of an Assert winner, wherein any ingress PE not selected as the Assert winner stops forwarding the data packets on the Data MDT; and
sending from the Assert winner periodic PIM control messages on the Default MDT to maintain the Assert state on all ingress PE routers.

16. The tangible non-transitory computer readable medium of claim 15, wherein the Assert winner is determined without a need to decapsulate the data packets at a PE device.

17. The tangible non-transitory computer readable medium of claim 15, wherein the Assert mechanism is triggered when the ingress PE device detects a PIM Join targeted towards another ingress PE device on a same multi-access segment.

18. The tangible non-transitory computer readable medium of claim 15, wherein the Assert message comprises a special bit extension, wherein the special bit extension forces an RPF neighbor to keep pointing to the Assert winner until a PIM neighborship-down event is detected.

19. The tangible non-transitory computer readable medium of claim 15, the process further comprising sending a Hello message with a special option field value to all connected PE devices to ensure that a PE device receiving the Assert message following the Hello message is configured to interpret the Assert message having the special bit extension.

20. The tangible non-transitory computer readable medium of claim 18, wherein the PIM neighborship-down event comprises an event selected from an Assert cancel message, expiration of the Assert winner state, and Bidirectional Forwarding Detection (BFD).
